(19) United States
(12) Patent Application Publication
(10) Pub. No.: US 2014/0075954 A1
(43) Pub. Date: Mar. 20, 2014

(54) Methods And Systems For Substance Profile Measurements In Gas Turbine Exhaust

(71) Applicants: Nilesh Tralshawala, Rexford, NY (US); Robert Joseph Iasillo, Atlanta, GA (US); Chayan Mitra, Bangalore (IN); Robert Frank Hoskin, Duluth, GA (US)

(72) Inventors: Nilesh Tralshawala, Rexford, NY (US); Robert Joseph Iasillo, Atlanta, GA (US); Chayan Mitra, Bangalore (IN); Robert Frank Hoskin, Duluth, GA (US)

(73) Assignee: General Electric Company, Schenectady, NY (US)

(21) Appl. No.: 13/617,192

(22) Filed: Sep. 14, 2012

(51) Int. Cl. F02C 7/00

(52) U.S. Cl. 60/779; 60/39.091

(57) ABSTRACT

Methods and systems for substance profile measurements in gas turbine exhaust. In an embodiment, a concentration of a substance may be determined and associated with a combustor out of a plurality of combustors. An alert may be transmitted in reference to the combustor when the concentration of the substance crosses a threshold level.

### TECHNICAL FIELD

The technical field generally relates to gas turbines and more specifically relates to gas turbine exhaust.

### BACKGROUND

A gas turbine typically comprises a compressor for compressing air and a combustor where the compressed air from the compressor and gas fuel are mixed and burned. The hot gases from the combustor drive the turbine stages to generate power. Normally, for installed turbines, performance monitoring is done through daily checks and measurements and periodic performance tests. The results are later used for maintenance and repair diagnostic processes. For example, after a fault occurs, the previously recorded trends of the machine are analyzed to identify the cause of failure and maintenance action required to recover from the identified failure.

Methods as described above generally are not able to predict and prevent significant turbine damage. Furthermore, due to inherent time delays associated with analyzing faults, determining failure causes, and identifying corrective action steps, use of present methods often results in undesirable lengths of repair time for critical turbine components.

### BRIEF DESCRIPTION OF THE INVENTION

Disclosed herein are methods and systems for substance profile measurements in gas turbine exhaust. In an embodiment, a method comprises determining a concentration of a substance at a location, identifying the substance at the location as associated with a first combustor component from a plurality of combustor components, and transmitting an alert in reference to the first combustor component when the concentration of the substance crosses a threshold level.

In an embodiment, a system may comprise a subsystem that determines a concentration of a substance at a location in a turbine, a subsystem that identifies the substance at the location as associated with a first combustor component out of a plurality of combustor components, and a subsystem that transmits an alert in reference to the first combustor component when the concentration of the substance crosses a threshold level.

In an embodiment, a system may comprise a plurality of probes, a processor adapted to execute computer-readable instructions, and a memory communicatively coupled to the processor. The memory may have computer-readable instructions that, if executed by the first processor, cause the processor to perform operations comprising determining a concentration of a substance at a location, identifying the substance at the location as associated with a first combustor out of a plurality of combustors, and transmitting an alert in reference to the first combustor when the concentration of the substance crosses a threshold level.

This Brief Description of the Invention is provided to introduce a selection of concepts in a simplified form that are further described below in the Detailed Description. This Brief Description of the Invention is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 is an exemplary illustration of a gas turbine;

FIG. 2 is an exemplary schematic that illustrates the exhaust outlet of a gas turbine illustrating combustion chambers and probes;

FIG. 3 is an exemplary swirl chart showing gas turbine output as a percent of capacity versus various swirl angles;

FIG. 4 illustrates a non-limiting, exemplary method of implementing a tracing gas method;

FIG. 5A illustrates an exemplary graph that displays probe locations and corresponding concentration levels of a gas;

FIG. 5B is an exemplary schematic that illustrates the exhaust outlet of a gas turbine illustrating combustion chambers and probes;

FIG. 6 is an exemplary illustration of an emission concentration monitoring system with in-situ tunable diode laser absorption spectroscopy;

FIG. 7 is an exemplary illustration of an emission concentration monitoring system using extraction line-select and tunable diode laser absorption spectroscopy;

FIG. 8 is an exemplary illustration of an emission concentration monitoring system using extraction and multiplexer tunable diode laser absorption spectroscopy; and

FIG. 9 is an exemplary block diagram representing a general purpose computer system in which aspects of the methods and systems disclosed herein or portions thereof may be incorporated;

FIG. 10 is an exemplary block diagram of a system for substance profile measurements in gas turbine exhaust.

### DETAILED DESCRIPTION OF THE INVENTION

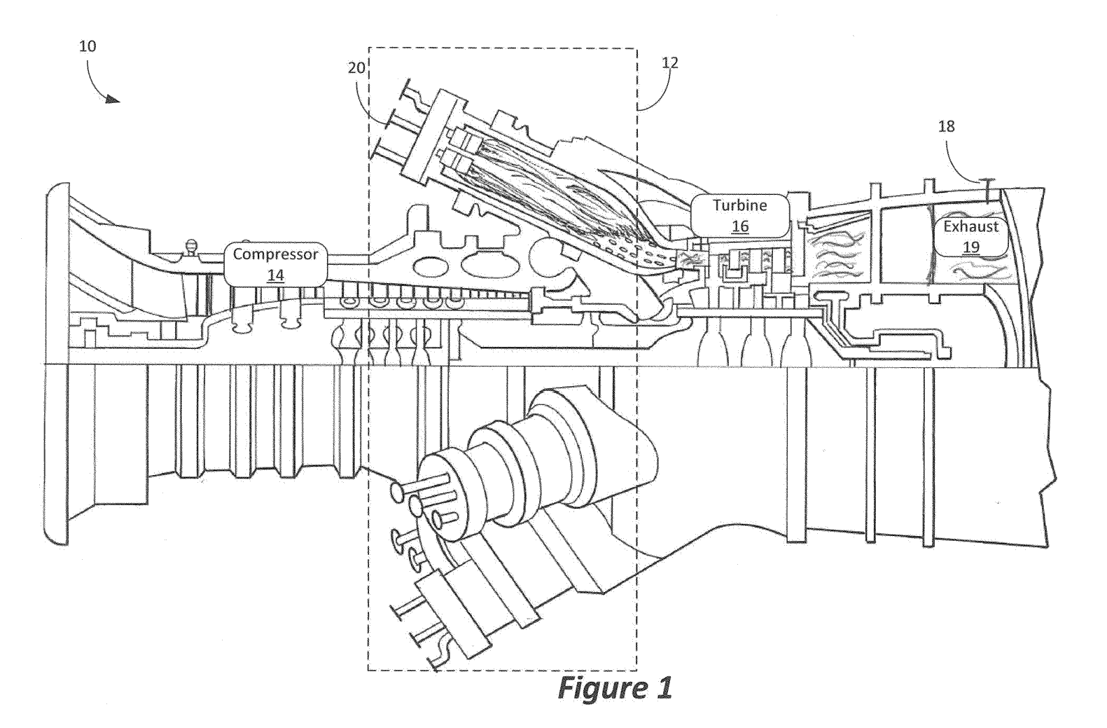

FIG. 1 is an exemplary illustration of a partial cross section of a gas turbine. As shown in FIG. 1, a gas turbine 10 has a combustion section 12 in a gas flow path between a compressor 14 and a turbine 16. The combustion section 12 may include an annular array of combustion components around the annulus. The combustion components may include combustion chamber 20, and attached fuel nozzles, for example. The turbine 16 is coupled to rotationally drive the compressor 14 and a power output drive shaft. Air enters the gas turbine 10 and passes through the compressor 14. High pressure air from the compressor 14 enters the combustion section 12 where it is mixed with fuel and burned. High energy combustion gases exit the combustion section 12 to power the turbine 16 which, in turn, drives the compressor 14 and the output power shaft. The combustion gases exit the turbine 16 through the exhaust duct 19. The exhaust duct 19 may include a probe 18. Probe 18 may be used to detect characteristics of exhaust gases, such as temperature of the gas or composition of the gas, among other things.

The combustion gases swirl partially around the axial centerline of the gas turbine 10, as the gases move axially through the turbine 16. This swirl of the combustion gases is due to the rotation of the turbine blades and the expansion of the hot gases moving from stage to stage. The amount of swirl in the combustion gases between the combustion section 12 and exhaust ducts 19 depends on hardware geometry and the operating condition of the gas turbine 10, such as its stage load, duty cycle, ambient temperature and other factors which change the mass flow and density moving through the turbine. When the combustion gases exit the exhaust duct 19, the gases have swirled about the axis of the gas turbine and may not axially align with the combustion chambers that generated the gases.

Analysis of the aforementioned exhaust swirls, for a given hardware design, during the operation of the gas turbine may assist in the determination of defective combustion chambers. A swirl chart may be created for a gas turbine using exhaust thermocouples and parameters that represent mass flow through the turbine. The swirl chart may help determine the originating combustion chamber of the exhaust at a specified fuel load.

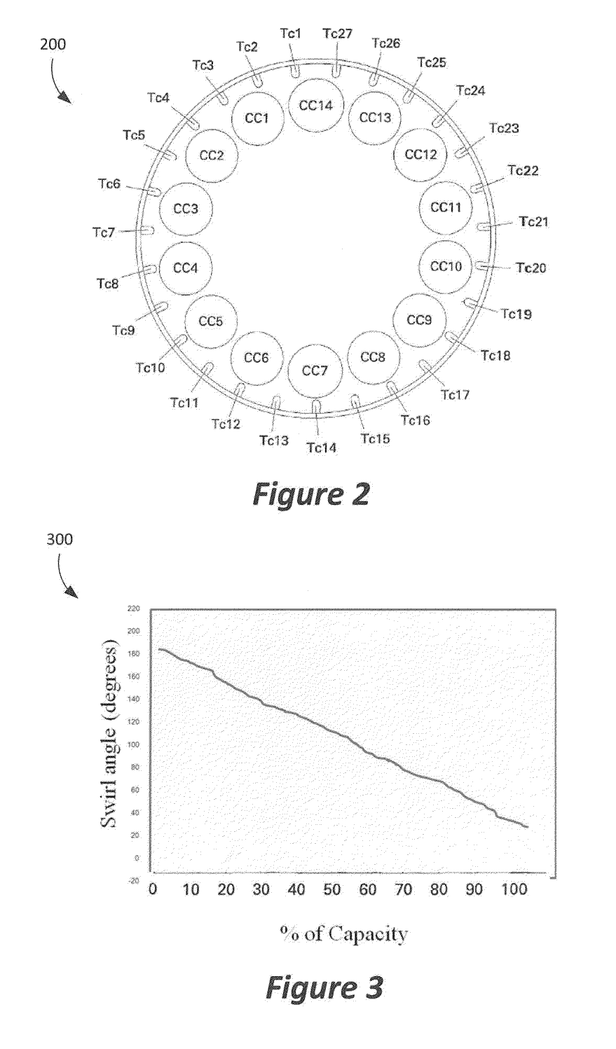

FIG. 2 is an exemplary schematic 200 that illustrates an exhaust outlet of a gas turbine illustrating fourteen combustion chambers (CC1, CC2, CC3 . . . CC14) and twenty-seven thermocouples (Tc1, Tc2, TC3 . . . Tc27). The thermocouples may constantly take the temperature of the exhaust gas. In gas turbines, exhaust temperature monitoring may be desirable since high temperatures may cause damage to combustor elements, hot gas path parts, rotor blades, and the like. Where the average of the exhaust temperature is typically used for closed loop control of parameters, they are also may be used to detect damage within the combustor cans and or turbine section. For example, if a fuel nozzle is plugged or damaged, a hotter or colder than normal temperature may result. The exhaust gas may also include emission levels of certain regulated compounds, such as nitrogen oxides (i.e., NOx, a group of different gases made up of different levels of oxygen and nitrogen), and/or carbon dioxide, which may also vary with combustion temperature and hardware condition. Some types of combustion hardware issues may produce larger changes in emission more than they do in overall temperature. Although some types of combustion damage show up in the analysis of exhaust thermocouple temperatures, not all do, nor is the level always detectable over general variation (e.g., noise) in the system. The normal accepted practice is to measure emission levels far down stream of the turbine exhaust to allow for mixing and allow for an average measurement method. Under some circumstances there may be enough damage to exceed overall emission levels or impact unit operation.

FIG. 3 is an exemplary swirl chart 300 displaying gas turbine output as a percent (0-100%) of capacity (in Megawatt) versus various swirl angles in degrees (−20 to 220°). Swirl angle values, shape of the plot, and other parameters may vary based on the type of gas turbine. Gas turbine output maybe used to correlate mass flow through the turbine. At low output mass flow and density, the swirl angle of exhaust gases increases as velocity of the exhaust gas decreases, when the turbine bucket speed is constant. At high output, where the fuel-air volume (mass flow and temperature) is high, the angle is low. The angle may be low because velocity of the gas is much higher through the fixed volume, which may result in a lower vector angle between the spinning bucket and the gas flowing through the turbine. The swirled exhaust gas may leave the last stage of the turbine, and may travel through the exhaust to exhaust probes that detect characteristics of the swirled exhaust gases.

The swirl angle may be impacted by the mechanical layout of the buckets (i.e., exit angle), as well as the distance between the last stage bucket of the turbine and exhaust probes. Swirl angle may be a function of the operation of the gas turbine once hardware of the gas turbine is in a fixed or consistent state. At low output, the swirl angle is likely to vary between combustor cans and have a high degree of uncertainty. Historically post event data was used to correlate combustion damage to hot or cold spots in the exhaust temperature to develop a swirl chart. Currently other processes, such as intentional fuel flow manipulations, have been used to develop swirl charts.

Swirl charts may indicate the angle between any combustion chamber and the point where the exhaust from the combustion chamber crosses the exhaust outlet of the gas turbine. In the arrangement described in FIG. 2, which shows fourteen combustion chambers, each combustion chamber occupies a segment equal to 360/14, or approximately 25.7 degrees. The swirl angle may be measured with reference to the center of the segment that each combustion chamber occupies. The angle may increase as the load on a gas turbine decreases. For example, if the load on the turbine is at 90% of the capacity, and the exhaust from combustion chamber #4 (CC4) crosses thermocouple #8 (Tc8) as viewed in FIG. 2, then operating the gas turbine at 50% of nameplate capacity may mean the exhaust exiting CC4 now crosses Tc10. Likewise, if the gas turbine is reduced to 25% of nameplate capacity, for example, then the exhaust from CC4 might cross Tc12. The swirl chart in FIG. 3 is a correlation between a specific combustion chamber and where its exhaust crosses the exhaust outlet of a gas turbine at specified loads. Thus, a swirl angle at 90% of nameplate capacity may be different than a swirl angle at 50% name plate capacity. A swirl chart showing the rotation of the turbine flows at many different percentages of nameplate capacity, for example, may allow one skilled in the art to be able to tune the gas turbine at any specified level (i.e., between 50% to 100% of nameplate capacity) and tune each and every combustion chamber so that the variation between each combustion chamber is now minimized Once the swirl data is determined, a computer may be employed to efficiently run the gas turbine at any level of nameplate capacity.

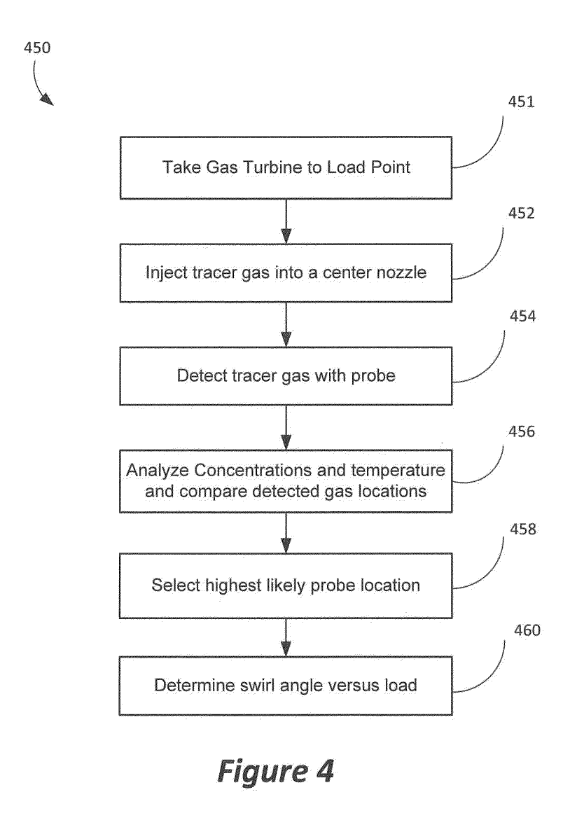

The injection of a substance such as a tracer gas or particle may help determine the originating combustion chamber of exhaust at a specified fuel load. In an embodiment, the substance may initially be a liquid or a solid that may transform into a gaseous state or produce a gaseous product, or the like before, after, or during its travel through a combustion chamber. FIG. 4 illustrates a non-limiting, exemplary method of implementing a tracer gas method 450. At block 451, a gas turbine may be taken to a load point (e.g., 20%). At block 452, the tracer gas may be injected into a combustor center nozzle as a marker. A tracer gas, such as Xenon or Argon that is not present in large amounts in fuel may be used because of its minimal effect on combustion. In an embodiment, a noble gas such as Argon or Xenon may be detected using Rayleigh scattering of an appropriate laser light—these gases may have unique scattering cross-sections and it is possible to detect them in the typical turbine exhaust gas mix. In an embodiment, the tracer gas may be a non-reactive gas that may not interfere with the combustion process.

In an embodiment at block 452, particles may be injected in a similar manner to a tracer gas. The choice of particle may be based on the ability of a particle to survive and not negatively alter combustion. An exemplary detection method may be Rayleigh scattering which may use the particle “talc.” Another exemplary detection method may include the use of fluorescent or luminescent particles. As these particles pass thru a laser light probe, a laser light at a different (e.g., longer) wavelength may be detected, thus enabling a method to detect swirl.

In an embodiment at block 452, N2O may be injected which may result in higher NOx, O2, and other emissions that may be detected after combustion. All emissions (NO, NO2, CO, CO2 & O2) may be monitored. In another embodiment, CO2 may be injected and the emissions monitored. The injection of different gases (N2O or CO2) may cause significantly different shifts in emissions and different directions in reading from the normal combustion operation. A minimal amount of gas may change the emissions, but not significantly change the firing temperature or mass flow. These embodiments, with regard to the injection of CO2, NO2, or the like, may be measured using tunable diode laser absorption spectroscopy (TDLAS) and may impact the temperature of the reaction the least, while shifting emissions. The tracer gas may be injected in one or more combustor locations to enable downstream determination of swirl. The injection may be a steady injection or happen at on-off measurement intervals. The injection amount may be metered to produce a bounded range of downstream concentrations.

At block 454, the tracer gas may be detected by a probe. The probe may operate using TDLAS or a Rayleigh scattering probe, for example. The gas concentration detection probe may be located at the same approximate location as a Tc probe. In an embodiment, the probe may have integrated functions such as the capability of measuring temperature and gas concentration. At block 456, the concentration of the tracer gas and other gases as well as the temperature may be measured an analyzed against a threshold. At block 458, the analysis of the gas concentration and temperature may alert a device and allow the device to determine the likely probe location for the associated nozzle injected with the tracer gas at the load point. At block 460, the swirl angle and load may be determined and recorded. Analysis of circumferential location with higher tracer gas concentrations may be used to determine the swirl angle. In an embodiment, this method may be repeated at different loads in order to create the table or chart that may allow for the determination of a source combustion chamber based on exhaust temperature or exhaust gas concentration at a particular load. Repetition of the method may allow for a more accurate chart.

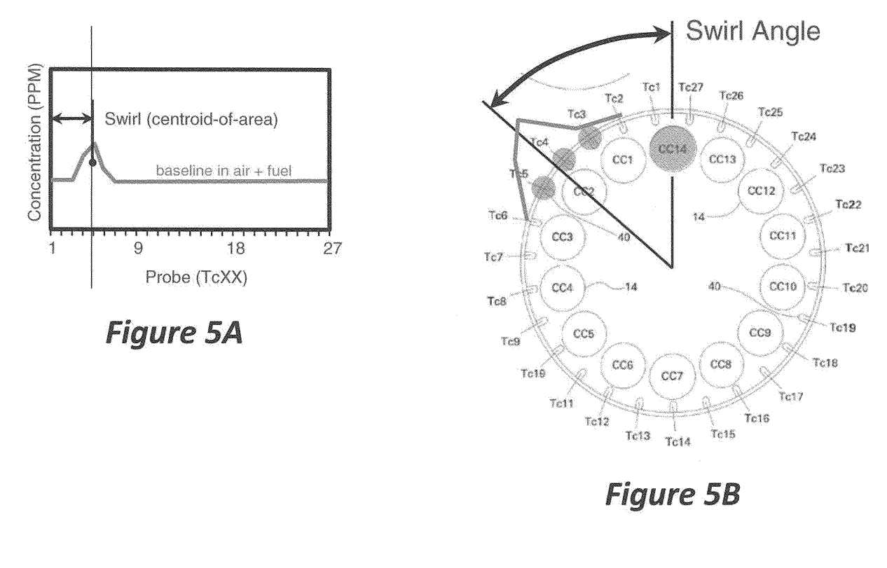

FIGS. 5A and 5B illustrate how monitoring and analysis of circumferential location tracer gas concentrations may be used to determine swirl angle. FIG. 5A illustrates an exemplary graph that displays probe locations and corresponding concentration levels of a tracer gas. For example, as displayed in FIG. 5B, if a tracer gas was injected into CC14, exhaust outlet gas concentration sensors may indicate a high concentration of the tracer gas at probe location Tc4, and the swirl angle may be adjusted accordingly. In the aforementioned embodiment, CC14 exhaust gases may have a determined location near Tc4 while the other combustion chambers relative locations would adjust accordingly from their standard/default positions (e.g., CC13 may be located near Tc3). In the embodiments of FIGS. 5A and 5B TDLAS probes are located in the same approximate location of the thermocouples (Tc). Generally, TDLAS probes may be positioned at or near the exhaust outlet locations of thermocouples, wherein the thermocouples may be used to take temperature measurements for diagnostic reasons as mentioned herein. The tracer gas injection embodiment may provide a way to determine swirl without changing combustion temperature. Other methods may require the constant change of combustion levels and recordation of temperatures to determine a source of an exhaust gas.

A measurement array comprising temperature measurement probes (e.g., thermocouple probes) and gas measurement probes (e.g., TDLAS probes) may be at or near the same location in order to more accurately diagnose issues with combustors and other parts of the gas turbine. The gas measurement devices may be tunable diode laser absorption spectroscopy probes or other chemical sensing technology for the detection of gases. Swirl charts may vary based on the design of the gas turbine.

Monitoring and diagnosis of individual combustor chamber problems may be done with further analysis of emissions. A damaged combustor chamber may produce high concentrations of emissions, such as NOx (nitrous oxide), O2 (oxygen gas), or CO (carbon monoxide). Emissions are measured in bulk today with assumed mixing to give average output. Emissions are sensitive to local damage not seen in bulk temperature. A method of combustor to combustor (can-to-can) detection using emission gas measurement may improve ability to assess the health state of individual combustors. Emission concentration measurements may be taken at the thermocouple plane in order to more accurately diagnose combustor issues.

Emission concentration monitoring may allow detection of combustion damage that is not related to changes in air flow and temperature that can be seen by exhaust outlet thermocouples. Combustion hardware damage (e.g., damage to the burner tube, nozzle, or liner) may shows up as increases in NOx or CO. CO turn up is a significant indication of lean blow-out potential and detection of CO, for example, may trigger automated measures to avert a pending blow out. This condition may be true for premixed and diffusion combustors with diluent (water/steam) combustors.

In an embodiment, there may be a system for in-situ measurement of emission. A circumferential profile may be measured in a gas turbine diffuser at an exhaust Tc plane. In-situ measurements may be accomplished by a tunable diode laser absorption spectroscopy (TDLAS) probe. An exhaust Tc shield and mount may be modified to create a fiber-optically fed laser probe that senses the same location of emissions gases as the exhaust thermocouples. The same amount of measurement channels as the exhaust Tc probes may be used for TDLAS probes in obtaining a complete profile. These profiles may be used for combustion hardware diagnostics and tuning purposes. Averaging or otherwise analyzing the emissions data from all probes may allow for a bulk emissions measurement, which may be used for emissions control.

In an embodiment, a specific absorption wavelength may be chosen for each species of gas to be measured. Each of these diodes may be time-division-multiplexed (TDM) or wavelength-division-multiplexed (WDM) into multiple probes. If the wavelengths are sufficiently apart, there is minimal chance of cross-talk for WDM and all the lasers may be run simultaneously for simultaneous emissions species measurements. Otherwise, TDM may be employed. Wavelength of each diode may be swept using a ramped diode injection current input. Gas species may be detected by absorption at a species specific wavelength. The detection sensitivity may be improved by applying ratiometric balanced detection where a reference laser output is used for temporal correlation. Sensitivity of measurements may be further improved by lock-in measurements at sweep frequency and its second harmonic and obtaining the 2f/1f signal ratio (ratio of second harmonic signal to first harmonic signal), which has been shown to be stable and minimally affected by instantaneous noise (vibrations) and drift (thermal). In addition, laser dependent variations may be may be excluded from probe to probe by multiplexing a single laser between all the measurement probes. Multiplexing allows the use of lasers with significantly reduced power in comparison to situations where a plurality of lasers are dedicated to a plurality of probes.

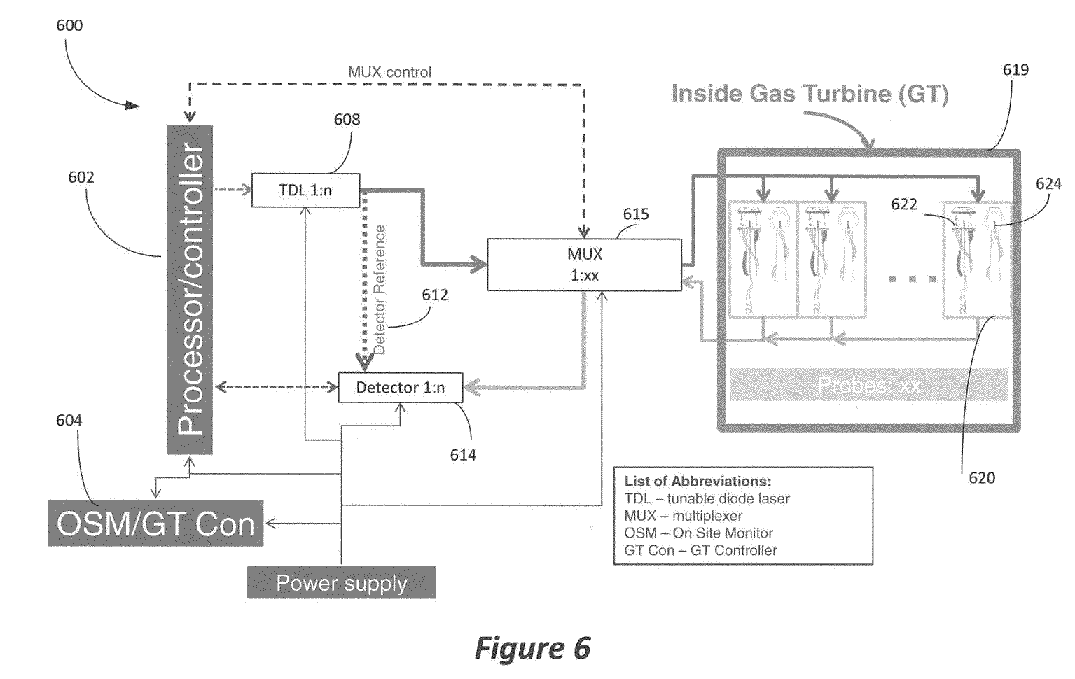

FIG. 6 is an exemplary illustration of an emission concentration monitoring system 600 with in-situ TDLAS. In-situ TDLAS may be done without any extraction of gases from the turbine. In an embodiment, at 608 a tunable diode laser (TDL) device may be configured with lasers for gas detection (e.g., O2, NO2, CO, or NO) or temperature detection and may feed the lasers into a MUX 615. MUX 615 may be associated with a plurality of probes 619 as shown in FIG. 2, for example. The plurality of probes 619 may be segmented in pairs. For example, at 620 there may be a pair of probes which consist of a temperature sensing probe 622 and a gas sensing probe 624. In an embodiment, the gas sensing probe 624 may be integrated with the temperature sensing probe, or may be independently installed with laser light bounced-off the inner barrel (or some other convenient surface that is either in the gas turbine or added to the probe specifically for this purpose) for enabling larger laser path length for higher detection sensitivity, as needed.

A detector 614 may receive a de-MUXed signal from MUX 615 and a reference signal 612 from TDL device 608 in order to determine the type of gas detected or temperature detected. The processor/controller 602 may be communicatively connected to devices such as the TDL device 608, detector 614, and MUX 615 and may control or process information in connection with the communicatively connected devices. Processor 602 may also be connected to an on-site monitor/gas turbine controller 604 or other gas turbine equipment, which may include equipment that may interact with the combustors of the gas turbine. There may be n number of lasers and detectors (shown as 1:n in FIGS. 6, 7, and 8). For example, n may be 4 if O2, CO, NO and NO2 are to be detected, or n may equal five if H2O is also to be detected. The value of n may increase or decrease depending on the number of species that need to be detected. Similarly, there may be xx number of probes (denoted as 1:xx), for example 27 or 31. The value of xx may depend on the configuration of the combustion hardware.

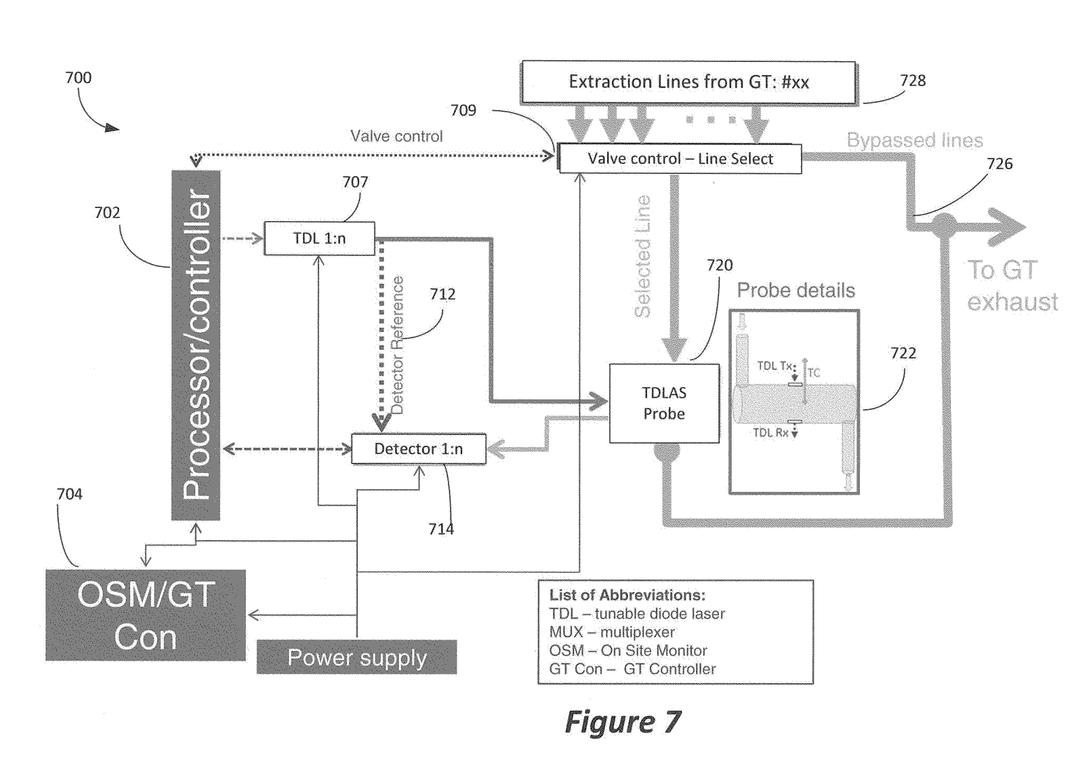

FIG. 7 is an exemplary illustration of an emission concentration monitoring system 700 using extraction line-select and TDLAS. Exhaust gas as may be extracted at different positions within the GT exhaust and one line out of a plurality may be used to examine properties of a selected gas line. In an embodiment, at 707 a tunable diode laser (TDL) device may be configured with lasers for gas detection (e.g., O2, NO2, CO, or NO) or temperature detection and may feed the lasers into a TDLAS probe 720. Here, one gas may be selected and the other lines of extracted gases may be fed into a bypass line 726 out to the GT exhaust. The extraction lines 728 may be positioned similar to probes as shown in FIG. 2, for example. Exemplary details of TDLAS probe 720 are shown at 722. TDLAS probe 720 may probe one gas selected from a plurality of gases extracted from the GT exhaust. The selected gas may be fed to the GT exhaust after gas properties have been examined.

A detector 714 may receive a de-MUXed signal from TDLAS probe 720 and may also receive a reference signal 712 from TDL device 707, in order to determine the type of gas detected or temperature detected. The processor/controller 702 may be communicatively connected to devices such as the TDL device 707, detector 714, and valve control 709. The processor/controller 702 may control or process information in connection with the communicatively connected devices. Processor 702 may also be connected to an on-site monitor/gas turbine controller 704 or other gas turbine equipment, which may include equipment that may interact with the combustors of the gas turbine.

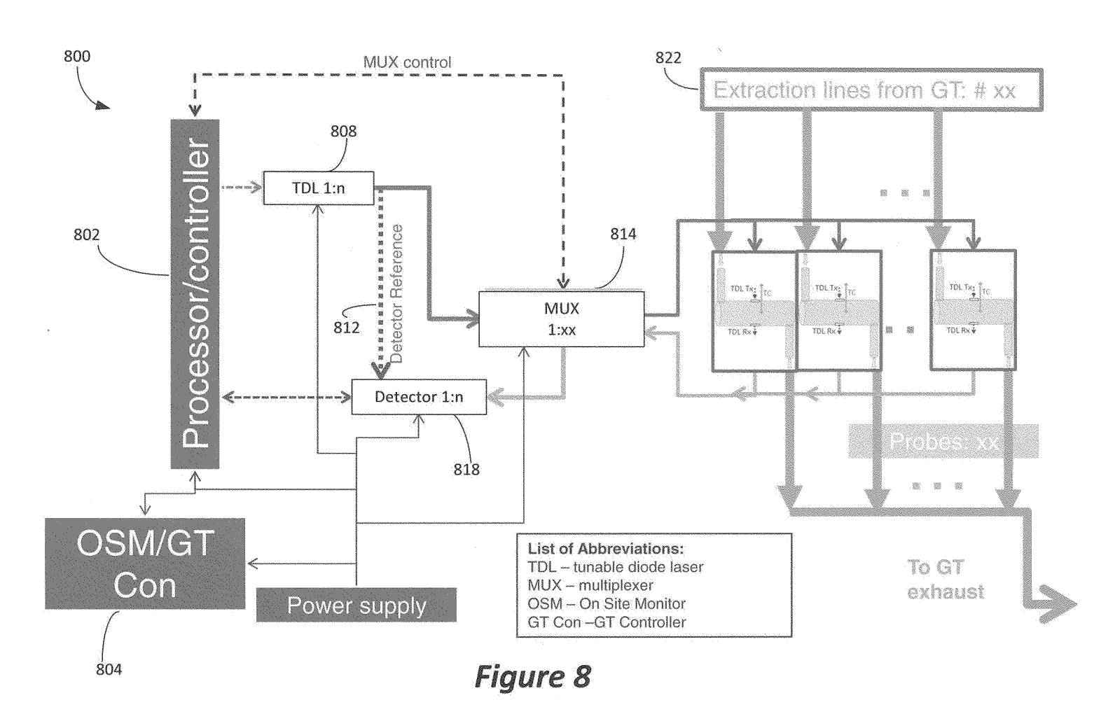

FIG. 8 is an exemplary illustration of an emission concentration monitoring system 800 using extraction and multiplexer (MUX) TDLAS. Gas may be extracted at different positions within the GT exhaust and each extraction line may have the properties of the gas in the selected line examined In an embodiment, at 808 a tunable diode laser (TDL) device may be configured with lasers for gas detection (e.g., O2, NO2, CO, or NO) or temperature detection and may feed the lasers into a MUX 814. MUX 814 may have lasers associated with a plurality of probes. The probes may have gas fed into them from extraction lines 822 placed the GT exhaust in a manner as shown in FIG. 2, for example.

A detector 614 may receive a de-MUXed signal from MUX 814 and a reference signal 812 from TDL device 808 in order to determine the type of gas detected or temperature detected. The processor/controller 802 may be communicatively connected to devices such as the TDL device 808, detector 818, and MUX 814. The processor 802 may control or process information in connection with the communicatively connected devices. Processor 802 may also be connected to an on-site monitor/gas turbine controller 804 or other gas turbine equipment, which may include equipment that may interact with the combustors of the gas turbine.

Systems discussed herein, may allow for real time, in-situ measurement and spatial distribution of emissions gases. Disclosed herein, among other things, is a system for spatially-distinct measurements to assess conditions of individual combustor cans. The system may also have a higher rate of response over methods that use extraction and mechanical devices such as valves and condensers. The fast response of the system may allow for real time, close loop emissions control. Enhanced NH3 control to reduce slip may replace feed forward estimates and calculations.

Combustor reactions may be automated using emission concentrations instead of, or in addition to, exhaust temperature measurements. For example emission concentrations may be used for can-to-can fuel tuning including optimization of emissions and other combustion dynamics rather than the cumulative or average readings of emissions of a gas turbine. The systems disclosed herein may analyze and react to emission readings so that a gas turbine may be tuned based on the emission or other gas readings associated with an individual can (e.g., outlier or dysfunctional can). For example, for CO or lean blow out, the gas turbine may be tuned based emission readings associated with an individual outlier can.

Without limiting the scope, interpretation, or application of the claims appearing herein, a technical effect of one or more of the example embodiments disclosed herein is to provide detection of combustion damage that is not related to changes in air flow and temperature that can be seen by exhaust outlet thermocouples. Another technical effect of one or more of the embodiments disclosed herein is tighter gas turbine and selective catalyst reduction (SCR) systems control may be enabled by real-time measurement of combustion gas composition exiting the gas turbine. The real-time sensor may preclude the need for “NOx forwarding” or complementary filtering.

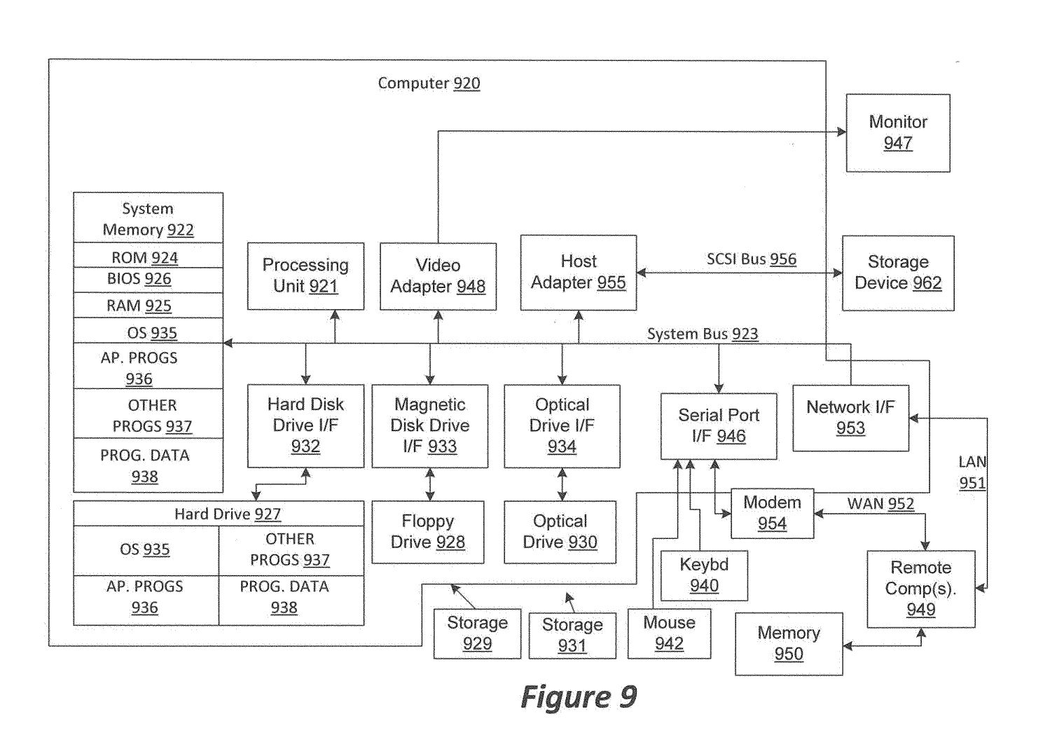

FIG. 9 and the following discussion are intended to provide a brief general description of a suitable computing environment in which the methods and systems disclosed herein and/or portions thereof may be implemented. For example, the automated control of combustion equipment based on can-to-can emission concentration detection. Although not required, the methods and systems disclosed herein may be described in the general context of computer-executable instructions, such as program modules, being executed by a computer, such as a client workstation, server or personal computer. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. The methods and systems disclosed herein may also be practiced in distributed computing environments where tasks are performed by remote processing devices that are linked through a communications network. In a distributed computing environment, program modules may be located in both local and remote memory storage devices.

FIG. 9 is a block diagram representing a general purpose computer system in which aspects of the methods and systems disclosed herein and/or portions thereof may be incorporated. As shown, the exemplary general purpose computing system includes a computer 920 or the like, including a processing unit 921, a system memory 922, and a system bus 923 that couples various system components including the system memory to the processing unit 921. The system bus 923 may be any of several types of bus structures including a memory bus or memory controller, a peripheral bus, and a local bus using any of a variety of bus architectures. The system memory includes read-only memory (ROM) 924 and random access memory (RAM) 925. A basic input/output system 926 (BIOS), containing the basic routines that help to transfer information between elements within the computer 920, such as during start-up, is stored in ROM 924.

The computer 920 may further include a hard disk drive 927 for reading from and writing to a hard disk (not shown), a magnetic disk drive 928 for reading from or writing to a removable magnetic disk 929, and an optical disk drive 930 for reading from or writing to a removable optical disk 931 such as a CD-ROM or other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide non-volatile storage of computer readable instructions, data structures, program modules and other data for the computer 920.

Although the exemplary environment described herein employs a hard disk, a removable magnetic disk 929, and a removable optical disk 931, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 929, optical disk 931, ROM 924 or RAM 925, including an operating system 935, one or more application programs 936, other program modules 937 and program data 938. A user may enter commands and information into the computer 920 through input devices such as a keyboard 940 and pointing device 942. Other input devices (not shown) may include a microphone, joystick, game pad, satellite disk, scanner, or the like. These and other input devices are often connected to the processing unit 921 through a serial port interface 946 that is coupled to the system bus, but may be connected by other interfaces, such as a parallel port, game port, or universal serial bus (USB). A monitor 947 or other type of display device is also connected to the system bus 923 via an interface, such as a video adapter 948. In addition to the monitor 947, a computer may include other peripheral output devices (not shown), such as speakers and printers. The exemplary system of FIG. 9 also includes a host adapter 955, a Small Computer System Interface (SCSI) bus 956, and an external storage device 962 connected to the SCSI bus 956.

The computer 920 may operate in a networked environment using logical connections to one or more remote computers, such as a remote computer 949. The remote computer 949 may be a personal computer, a server, a router, a network PC, a peer device or other common network node, and may include many or all of the elements described above relative to the computer 920, although only a memory storage device 950 has been illustrated in FIG. 9. The logical connections depicted in FIG. 9 include a local area network (LAN) 951 and a wide area network (WAN) 952. Such networking environments are commonplace in offices, enterprise-wide computer networks, intranets, and the Internet.

When used in a LAN networking environment, the computer 920 is connected to the LAN 951 through a network interface or adapter 953. When used in a WAN networking environment, the computer 920 may include a modem 954 or other means for establishing communications over the wide area network 952, such as the Internet. The modem 954, which may be internal or external, is connected to the system bus 923 via the serial port interface 946. In a networked environment, program modules depicted relative to the computer 920, or portions thereof, may be stored in the remote memory storage device. It will be appreciated that the network connections shown are exemplary and other means of establishing a communications link between the computers may be used.

Computer 920 may include a variety of computer readable storage media. Computer readable storage media can be any available media that can be accessed by computer 920 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 920. Combinations of any of the above should also be included within the scope of computer readable media that may be used to store source code for implementing the methods and systems described herein. Any combination of the features or elements disclosed herein may be used in one or more embodiments.

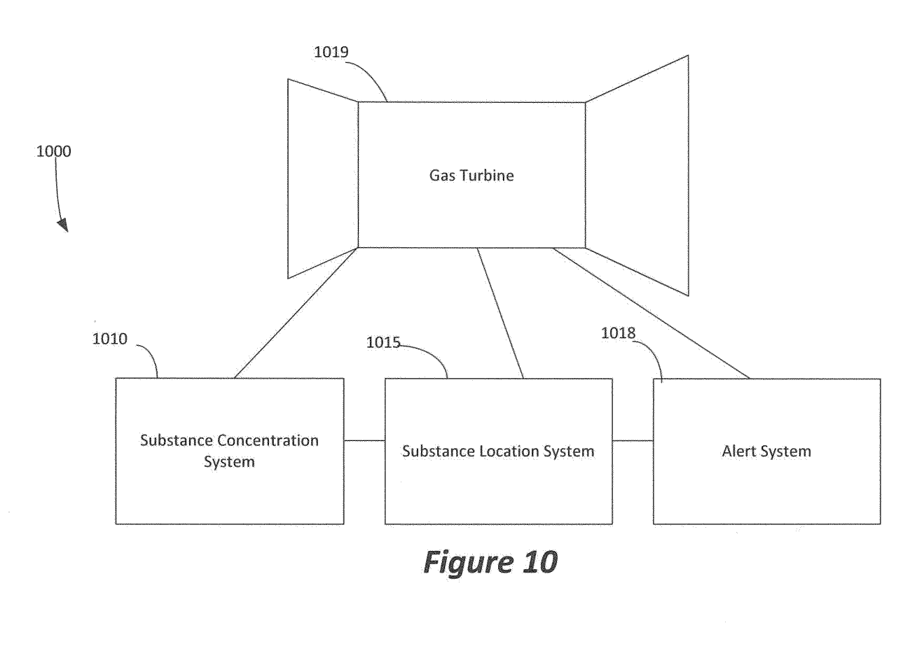

FIG. 10 is an exemplary illustration of a system 1000 for substance profile measurements in gas turbine exhaust. In an embodiment, a concentration of a substance may be detected by a substance concentration system 1010. The substance concentration system may detect a gas, liquid, or other substance by using applicable methods such as TDLAS or Rayleigh scattering, for example. The substance concentration system 1010, a substance location system 1015, and an alert system 1018 may be communicatively connected to each other. The substance location system 1015 may detect a location of the substance by using probes positioned throughout the exhaust end of the gas turbine. The alert system 1018 may analyze the concentration of a substance based on a predetermined threshold. The threshold may be based on a comparison of the concentration of the substance during normal operation of the gas turbine or a comparison of the amount of the substance based on the amount injected into the combustion section, for example. System 1010, 1015, and 1018 may communicate and control a plurality of gas turbine components 1019. The system 1000 may comprise processor, memory, and other computing devices mentioned herein. The subsystems may be consolidated into one device or distributed among several devices.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims. As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

What is claimed:

1. A method comprising:
determining a concentration of a substance at a location in a gas turbine;
identifying the substance at the location as associated with a first combustor component from a plurality of combustor components; and
transmitting an alert in reference to the first combustor component when the concentration of the substance crosses a threshold level.

2. The method of claim 1, wherein the substance is at least one of a noble gas, an emission, and a non-reactive gas.

3. The method of claim 1, wherein the gas is at least one of nitrous oxide or carbon dioxide.

4. The method of claim 2, wherein the emission comprises at least one of carbon monoxide, carbon dioxide, nitric oxide, nitrogen dioxide, nitrous oxide, and oxygen gas.

5. The method of claim 1, wherein determining the concentration of the substance comprises measuring the concentration of the substance by tunable diode laser absorption spectroscopy.

6. The method of claim 1, wherein determining the concentration of the substance comprises measuring the concentration of the substance by Rayleigh scattering, fluorescence, or luminescence.

7. The method of claim 1, wherein identifying the substance at the location as associated with a first combustor component comprises analyzing circumferential location of the concentration of the substance to determine a swirl angle.

8. A system comprising:
a subsystem that determines a concentration of a substance at a location in a turbine;
a subsystem that identifies the substance at the location as associated with a first combustor component out of a plurality of combustor components; and
a subsystem that transmits an alert in reference to the first combustor component when the concentration of the substance crosses a threshold level.

9. The system of claim 8, wherein the substance is at least one of a noble gas, an emission, and a non-reactive gas.

10. The system of claim 8, wherein the gas is at least one of nitrous oxide or carbon dioxide.

11. The system of claim 9, wherein the emission comprises at least one of carbon monoxide, nitric oxide, nitrogen dioxide, nitrous oxide, and oxygen gas.

12. The system of claim 8, wherein the subsystem that determined the concentration of the substance comprises a tunable diode laser absorption spectroscopy.

13. The system of claim 8, wherein the subsystem that determines the concentration of the substance comprises an instrument that measures concentration by at least one of Rayleigh scattering, fluorescence, or luminescence.

14. The system of claim 8, wherein the subsystem that identifies the substance at the location with a first combustor component comprises a subsystem that analyzes a circumferential location of the concentration of the substance to determine a swirl angle.

15. A system comprising:
a plurality of probes;
a processor in communication with a probe of the plurality of probes configured to execute computer-readable instructions; and
a memory communicatively coupled to said processor, the memory having stored therein computer-readable instructions that, if executed by the first processor, cause the processor to perform operations comprising:
determining a concentration of a substance at a location, wherein the substance comprises at least one of gas or particle;
identifying the substance at the location as associated with a first combustor or fuel nozzle out of a plurality of combustors or fuel nozzles; and
transmitting an alert in reference to the first combustor when the concentration of the substance crosses a threshold level.

16. The system of claim 15, wherein a probe of the plurality of probes is a tunable diode laser absorption spectroscopy probe.

17. The system of claim 15, further comprising computer-readable instructions of:
injecting the substance into a combustor center nozzle, wherein the substance is a non-reactive, having minimal effect on combustion.

18. The system of claim 15, further comprising computer-readable instructions of:
tuning combustion dynamics of a gas turbine based on the identified substance at the location as associated with the first combustor or fuel nozzle.

19. The system of claim 15, further comprising computer-readable instructions of:
creating an exhaust profile for a gas turbine based on measurements obtained from at least one of the plurality of probes.

20. The system of claim 15, further comprising computer-readable instructions of:
processing emissions data from the plurality of probes for a bulk emissions measurement; and
using the bulk emissions measurement for emission control.
